(19) United States
(12) Patent Application Publication
(10) Pub. No.: US 2012/0250983 A1
(43) Pub. Date: Oct. 4, 2012

(54) OBJECT DETECTING APPARATUS AND METHOD

(75) Inventors: Long MENG, Beijing (CN); Weiguo WU, Beijing (CN)

(73) Assignee: Sony Corporation, Tokyo (JP)

(21) Appl. No.: 13/429,748

(22) Filed: Mar. 26, 2012

(30) Foreign Application Priority Data
Mar. 30, 2011 (CN) 201110085794.2

(51) Int. Cl. G06K 9/62

(52) U.S. Cl. 382/159

(57) ABSTRACT

An object detecting apparatus and method is disclosed. An object detecting apparatus comprises: a detection classifier, configured to detect an object in an input image to obtain one or more candidate objects; a verifying classifier, configured to verify each candidate object by using verifying features from an image block corresponding to the each candidate object; and an on-line learning device, configured to train and optimize the detection classifier by using image blocks corresponding to the candidate objects as on-line samples, based on verifying results of the candidate objects obtained by the verifying classifier.

The application claims priority to Chinese Patent Application No. 201110085794.2, filed with the Chinese Patent Office on Mar. 30, 2011 and entitled “Object Detecting Apparatus And Method”, which is hereby incorporated by reference in its entirety.

### FIELD

The present disclosure relates to the field of object detection, and particularly to an apparatus and method for detecting an object in an image.

### BACKGROUND

As one of core technologies in automatic image/video analysis, object detection is widely applied to various application scenarios, such as video monitoring, artificial intelligence, and computer vision, etc. In an object detecting method, a classifier for object detection is generated by off-line training, and then is used to detect an object in an image or an image sequence (such as video). Since the training samples used in the off-line training are limited in number and not all of them are completely suitable to the application scenario, the classifier thus generated may result in a high error detection rate. In view of this, an on-line learning method is proposed, in which the image frames obtained on-line are used as training samples to train the classifier for object detection. Related documents regarding such on-line learning includes the following: Oza, et al., “Online Bagging and Boosting”, Proc. Artificial Intelligence and Statistics, 2001, Page 105-112 (hereinafter referred to as document 1).

### SUMMARY

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

According to an aspect of the disclosure, an object detecting apparatus is provided. The object detecting apparatus may include: a detection classifier, configured to detect an input image to obtain one or more candidate objects in the input image; a verifying classifier, configured to verify each candidate object by using verifying features from an image block corresponding to the each candidate object; and an on-line learning device, configured to train and optimize the detection classifier by using image blocks corresponding to the candidate objects as on-line samples, based on verifying results of the candidate objects obtained by the verifying classifier.

According to another aspect of the disclosure, an object detecting method is provided. The object detecting method may include: detecting, by a detection classifier, an input image to obtain one or more candidate objects in the input image; verifying, by a verifying classifier, each candidate object by using verifying features from an image block corresponding to the each candidate object; and training and optimizing the detection classifier by using image blocks corresponding to the candidate objects as on-line samples, based on verifying results of the candidate objects.

In addition, some embodiments of the disclosure further provide computer program for realizing the above method.

Further, some embodiments of the disclosure further provide computer program products in at least the form of computer-readable medium, upon which computer program codes for realizing the above method are recorded.

### BRIEF DESCRIPTION OF DRAWINGS

The above and other objects, features and advantages of the embodiments of the disclosure can be better understood with reference to the description given below in conjunction with the accompanying drawings, throughout which identical or like components are denoted by identical or like reference signs. In addition the components shown in the drawings are merely to illustrate the principle of the disclosure. In the drawings:

FIG. 1 is a schematic block diagram illustrating the structure of an object detecting apparatus according to an embodiment;

FIG. 2 is a schematic flow chart showing an object detecting method according to the embodiment;

FIG. 3 is a schematic block diagram illustrating the structure of an object detecting apparatus according to another embodiment;

FIG. 4 is a schematic flow chart showing an object detecting method according to the embodiment;

FIG. 5 is a schematic flow chart illustrating a method of detecting an object by a detection classifier according to a particular embodiment;

FIG. 6 is a schematic flow chart illustrating a method of verifying the detection result of the detection classifier by a verifying classifier according to a particular embodiment;

FIG. 7 is a schematic flow chart illustrating an on-line method of training and optimizing a detection classifier according to a particular embodiment;

FIG. 8 is a schematic flow chart illustrating an on-line method of generating and optimizing a verifying classifier according to a particular embodiment;

FIG. 9 is a schematic diagram illustrating on-line selecting of verifying features to be used by a verifying classifier; and

FIG. 10 is a schematic block diagram illustrating the structure of computer for realizing the disclosure.

### DETAILED DESCRIPTION

Some embodiments of the present disclosure will be described in conjunction with the accompanying drawings hereinafter. It should be noted that the elements and/or features shown in a drawing or disclosed in an embodiments may be combined with the elements and/or features shown in one or more other drawing or embodiments. It should be further noted that some details regarding some components and/or processes irrelevant to the disclosure or well known in the art are omitted for the sake of clarity and conciseness.

Some embodiments of the present disclosure provide an apparatus and method for detecting an object in an image. In the present disclosure, the term “image” may refer to a still image or a set of still images, or may refer to an image sequence, such as video images.

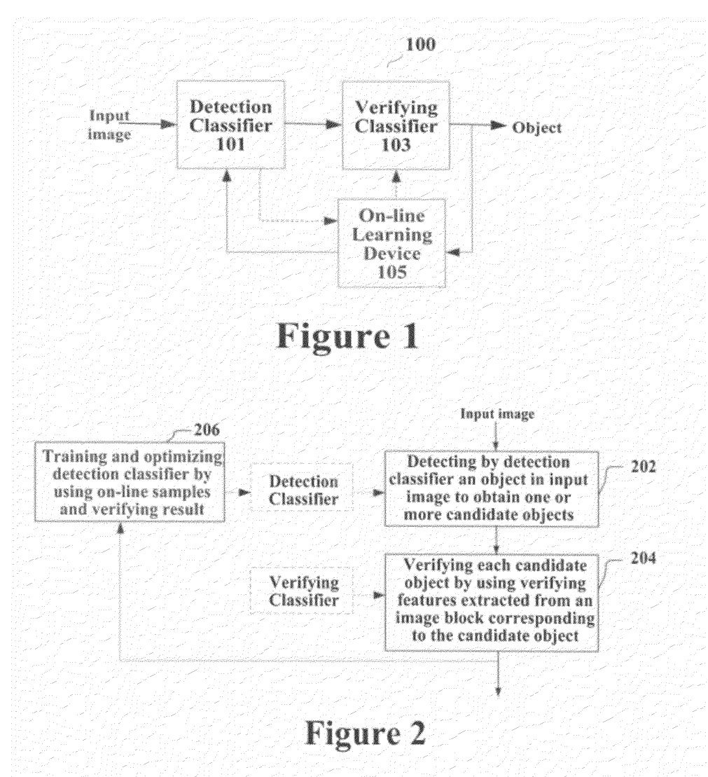

FIG. 1 shows the structure of an object detecting apparatus according to an embodiment, and

FIG. 2 shows the flow of an object detecting method according to the embodiment.

As shown in FIG. 1, the object detecting apparatus 100 may include a detection classifier 101, a verifying classifier 103 and the on-line learning device 105. The object detecting apparatus 100 may use the method as shown in FIG. 2 to detect an object in an input image. The components of the object detecting apparatus 100 are described below with reference to FIG. 2.

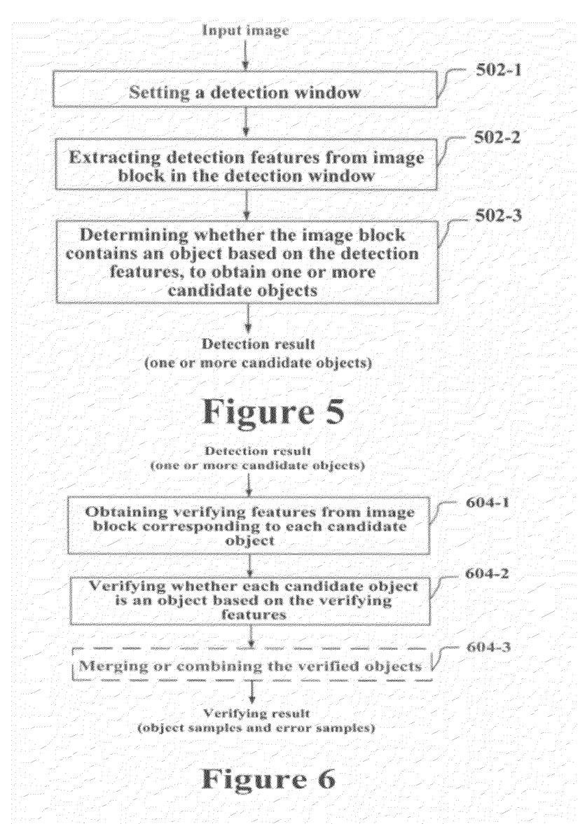

The detection classifier 101 is configured to detect an object in an input mage (step 202), and output the detection result to the verifying classifier 103. In the description, one or more objects detected by the detection classifier are referred to as candidate objects. The detection classifier may perform object detection by using any appropriate method. As an example, the detection classifier may utilize the method to be described below as an example with reference to FIG. 5.

The verifying classifier 103 is configured to verify the detection result obtained by the detection classifier 101 (step 204). The detection result may include one or more candidate objects detected by the detection classifier, for example, the position and size of each candidate object in the input image. As an example, the detection result may further include other information regarding each candidate object, for example, the detection probability of each candidate object (i.e. the probability of the detection classifier judging that each candidate object is an object) or the like.

Particularly, when verifying each candidate object detected by the detection classifier, the verifying classifier 103 may obtain one or more features (hereinafter referred to as “verifying features”) from the image block corresponding to each candidate object, and utilize the verifying features to verify whether each candidate object is an object or an error detection.

If a candidate object is verified as an object, the image block corresponding this candidate object may be used an on-line object sample; and if a candidate object is verified as an error detection, the image block corresponding this candidate object may be used an on-line error sample.

The verifying classifier 103 outputs the verifying result (which includes verification information indicating whether each candidate object is an object and the position and size of each candidate object) to the on-line learning device 105. The on-line learning device 105 utilize the verifying information of each candidate object obtained by the verifying classifier 103 to train the detection classifier 101 by using the image blocks corresponding to the candidate objects as on-line training samples (which include the above mentioned on-line object sample and the on-line error sample) (step 206). In this way, the detection classifier is optimized, and the subsequent image processing may use this optimized detection classifier in object detection.

In the apparatus or method shown in FIG. 1 or FIG. 2, two classifiers, i.e. the detection classifier and the verifying classifier, are used. The latter, i.e. the verifying classifier may verify the detection result obtained by the detection classifier, so as to further improve the accuracy of the object detection and to reduce detection error and omission. In addition, in the embodiment the detection classifier may be trained on-line according to the verifying result obtained by the verifying classifier and by using the on-line training samples (also called as on-line samples). The detection classifier thus optimized is more adaptable to the application scenario, thereby further improving the accuracy of object detection.

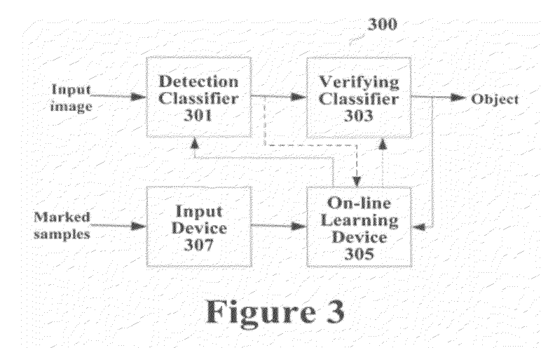

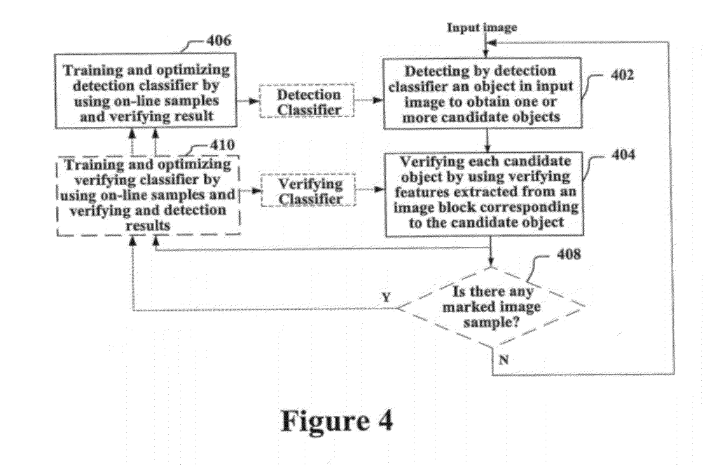

FIG. 3 shows the structure of an object detecting apparatus according to another embodiment, and FIG. 4 shows the flow of an object detecting method according to the embodiment.

As shown in FIG. 3, similar to the above object detecting apparatus 100, the object detecting apparatus 300 includes a detection classifier 301, a verifying classifier 303 and an on-line learning device 305. The difference lies in that the object detecting apparatus 300 further includes an input device 307.

The object detecting apparatus 300 may detect an object in an input image according to the method shown in FIG. 4. The components of the object detecting apparatus 300 are described below with reference to FIG. 4.

Similar to the embodiment as shown in FIG. 1, the detection classifier 301 is configured to detect an object in an input image, to obtain one or more candidate objects (step 402), and outputs the detection result to the verifying classifier 403. The verifying classifier 403 is configured to verify the detection result obtained by the detection classifier 301, that is, to determine whether each candidate object is an object or an error detection by using one or more detection features extracted from the image block corresponding to each candidate object (step 404), and outputs the verifying result. If a candidate object is verified as an object, the image block corresponding this candidate object may be used an on-line object sample; and if a candidate object is verified as an error detection, the image block corresponding this candidate object may be used an on-line error sample.

The input device 307 is configured to receive marked image samples. For example, when the output verifying result includes detection error or omission, a user may manually mark the image that contains the error or omission and input the marked image sample via the input device 307.

The marked image samples, together with the image blocks (i.e. the above mentioned on-line object samples and the on-line error samples) corresponding to the candidate objects, may be used as the on-line samples. The on-line learning device 305 may utilize these on-line samples to train and optimize the detection classifier 301 (step 406).

In the apparatus or method shown in FIG. 3 or FIG. 4, in addition to the verifying result obtained by the verifying classifier, the marked image samples are also used to optimize the detection classifier. Compared with the embodiment as shown in FIGS. 1-2, in the embodiment of FIGS. 3-4 the on-line optimization result of the detection classifier can be improved, and thus the accuracy of object detection may be further improved and the detection error and omission may be reduced.

FIG. 5 shows an exemplary flow of object detection (e.g. step 202 or 402) performed by a detection classifier (e.g. the detection classifier 101 or 301).

As shown in FIG. 5, in step 502-1, the detection classifier sets a detection window, moves the detection window in the input image frame to obtain a plurality of image blocks located in different positions of the input image frame.

The size and position of the detection window may be set according to practical application scenario, the description of which is omitted here. When detecting an object in an image frame, the size of the detection window may keep fixed, or may be changed. When the size of the detection window changes, the size of image block obtained by using the detection window changes correspondingly. As an example, the size of the detection window may be fixed, while the input image may be scaled, thus the obtained image blocks may be same in size.

In step 502-2, one or more features (referred to as detection features) are extracted from each image block obtained by using the detection window. The extracted detection feature may be any appropriate feature, such as Haar feature or Histogram of Oriented Gradient (HOG) feature, etc, and may be selected according to the practical application scenario, the description of which is omitted here.

Then in step 502-3, the detection classifier determines whether each image block contains any object according to the one or more detection features (also referred to as a set of detection features) extracted from this image block. As an example, the detection classifier may calculate the probability that each image block contains an object, and judges whether the value of the probability is larger than a predetermined threshold, if yes, determines that this image block contains an object, otherwise, determines that his image block contains no object. For example, it is supposed that the number of detection windows is m (that is, m image blocks are obtained) and the probability that the ith image block contains an object is represented by pᵢ (i=0, 1, . . . , m), the detection classifier may sets the image blocks that satisfies “pᵢ>T1” as the candidate objects, and records the sizes and positions of these candidate objects. T1 represents the predetermined threshold. It shall be appreciated that, the threshold may be selected according to the practical application scenario, the description of which is omitted here.

It shall be appreciated that, the method described above with reference to FIG. 5 is only an example, and the disclosure should not be limited to this. The detection classifier may use any other appropriate method to detect an object in an input image. For example, the detection classifier may be a classifier based on Adaboost, or a classifier based on support vector machine (SVM), or the like.

FIG. 6 illustrates the method of verifying (e.g. step 204 or 404) by a verifying classifier the detection result (one or more candidate objects) obtained by the detection classifier (e.g. the verifying classifier 103 or 303).

As shown in FIG. 6, in step 604-1, the verifying classifier obtains one or more verifying features (also referred to as a set of verifying features) of the image block corresponding to each candidate object.

As an example, the set of verifying features may be a subset of the set of detection features used by the detection classifier in object detection and in this case, the detection classifier may directly output the set of detection features to the verifying classifier, or the detection classifier may store the set of detection features in a storage device (not shown, the storage device may be a memory built in the object detecting apparatus, or may be a storage unit that is configured outside the object detecting apparatus and may be accessed by the components of the object detecting apparatus), and the detection classifier may directly read the features from the storage device.

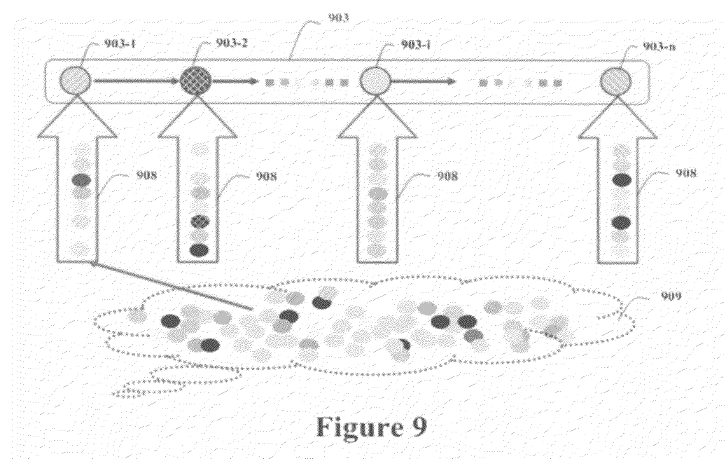

As another example, the verifying classifier may utilize features that are different from the detection features used by the detection classifier, as the verifying features. That is, the set of verifying features may be different from the set of detection features. For example, the set of verifying features may be a set of features that are set in advance. For another example, the set of verifying features may be a set of features that are selected on-line by the object detecting apparatus (e.g. the on-line learning device), as described below with reference to FIG. 8 and FIG. 9. Any appropriate features, such as Haar feature or HOG feature, may be selected according to practical application scenario (e.g. according to the type of the object, etc), as the verifying features, the description of which is omitted here.

In the case that the set of verifying features is different from the set of detection features, the object detecting apparatus (e.g. the verifying classifier) may extract the verifying features in the image block corresponding to each candidate object.

Then in step 604-2, the verifying classifier determines whether each candidate object is an error detection based on the one or more verifying features. A candidate object that is determined as an object may be referred to as a verified object.

As an example, the verified objects obtained in step 604-2 may be further processed. For example, multiple image blocks (i.e. multiple verified objects) that are verified as objects and are similar in size and position to each other may represent a same object, therefore these multiple image blocks that represent the same object and are close to each other in position and size may be merged as one object, which is also referred to as merged object.

It shall be appreciated that, the method described above with reference to FIG. 6 is only an example, and the disclosure should not be limited to this. The verifying classifier may use any other appropriate method to verify the candidate objects. For example, the verifying classifier may be a classifier based on Adaboost, or a classifier based on support vector machine (SVM), or the like.

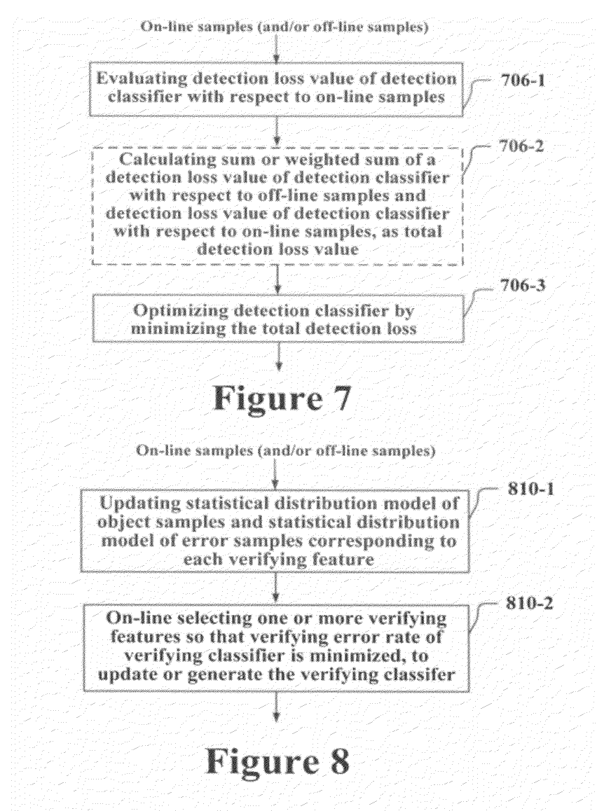

FIG. 7 shows an example of on-line training and optimizing (e.g. step 206 or 406) a detection classifier (e.g. the detection classifier 101 or 301) by the on-line learning device (e.g. the on-line learning device 105 or 305).

As shown in FIG. 7, in step 706-1 the on-line learning device evaluates the detection loss of the detection classifier with respect to the on-line samples. The on-line samples may include the image blocks corresponding to every candidate objects that are verified by the verifying classifier, i.e. the on-line object samples and the on-line error samples. In the case as shown in FIG. 3 or FIG. 4, the on-line samples may further include image samples marked manually by the user.

As an example, it is supposed that the detection loss of the detection classifier with respect to the on-line samples is represented by lossₒₙ, the on-line learning device may evaluate the detection loss lossₒₙ based on the following formula:

$${loss}_{on} = {\sum }_{i}^{ } {w}_{i} {\prod }_{n}^{ } {( {y}_{i} - {h}_{n} ( {x}_{i} ) )}^{2} \qquad ( 1 )$$

Wherein, n represents the number of the on-line samples; 0≦i≦n; yᵢ represents the type of an on-line samples, i.e. whether an on-line samples is an object or background; xᵢ represents a feature value of the on-line sample; wᵢ represents the weight of the on-line sample; hₙ(·) represents the output value of the detection classifier when the on-line sample is used as the input.

In step 706-2 [symbol] , the on-line learning device calculates the sum or weighted sum of the detection loss of the detection classifier with respect to the on-line samples and the detection loss of the detection classifier with respect to off-line samples, as the total detection loss. The off-line samples are image samples obtained off-line, for example, they may be the verified objects and/or candidate objects obtained by the object detecting apparatus when processing a previous image frame. The off-line samples may be saved in a storage device (not shown, the storage device may be a memory built in the object detecting apparatus, or may be a storage unit that is configured outside the object detecting apparatus and may be accessed by the components of the object detecting apparatus). The on-line learning device may read the off-line samples from the storage device.

As an example, the detection loss of the detection classifier with respect to the off-line samples may be pre-stored in the storage device. As another example, the on-line learning device may evaluate the detection loss loss_{off} of the detection classifier with respect to the off-line samples based on the following formula:

$$\begin{matrix}\begin{matrix}{loss}_{off} = {\prod }_{n} {loff}_{off , n} \\ = {\prod }_{n}^{ } {\sum }_{i}^{ } ( {y}_{i} - {{h}_{n} ( {x}_{i} )}^{2} \\ \approx {\prod }_{n}^{ } \int [ {p}_{n} ( z \vert y ) \times {( y - z )}^{2} ] \\ = {\prod }_{n}^{ } [ {{p}_{n , 1} ( 1 - {a}_{n} )}^{2} + {{p}_{n , 2} ( 1 + {a}_{n} )}^{2} + \\ {{p}_{n , 3} ( 1 - {b}_{n} )}^{2} + {{p}_{n , 4} ( 1 + {b}_{n} )}^{2} ) wherein ,\end{matrix} & ( 2 ) \\ {p}_{n} ( z \vert y ) = \{ \begin{matrix}{p}_{n , 1} & ( y = 1 , z = {a}_{n} ) \\ {p}_{n , 2} & ( y = - 1 , z = {a}_{n} ) \\ {p}_{n , 3} & ( y = 1 , z = {b}_{n} ) \\ {p}_{n , 4} & ( y = - 1 , z = {b}_{n} )\end{matrix} & ( 3 )\end{matrix}$$

In the above formula, the classifier may include weak classifiers obtained from Gentle Adaboost training method. Each weak classifier have two possible output values, aₙ and bₙ respectively represents the two output values of the nth weak classifier; loff_{off,n} represents the detection loss with respect to the off-line samples in the nth weak classifier of the detection classifier; p_{n,1} represents the probability that the output value of the nth weak classifier is aₙ when a positive sample is an input, p_{n,2} represents the probability that the output value of the nth weak classifier is aₙ when a background sample is an input, p_{n,3} represents the probability that the output value of the nth weak classifier is bₙ when a positive sample is an input, p_{n,4} represents the probability that the output value of the nth weak classifier is bₙ when a background sample is an input; y represents the type of a sample, i.e. whether a sample is an object sample or a background sample; z represents the output of the weak classifiers; pₙ(z|y) represents the probability of the various output value when the samples are input into the nth weak classifier.

As an example, the on-line learning device may calculate the total detection loss loss based on the following formula:

loss=(1−λ)×loss_{off}+λ×lossₒₙ (4)

Wherein λ represents a weight value, 0≦λ≦1. The value of λ may be determined according to practical application scenario, and should not be limited to any particular value.

The step 706-2 is optional. In another example this step may be omitted, instead, the detection loss value of the detection classifier with respect to the on-line samples obtained in step 706-1 may be used as the.

In step 706-3, the on-line learning device optimizes or updates the detection classifier by minimizing the total detection loss.

As an example, for any change Δ of the detection classifier (i.e. any adjustment to the detection classifier), the corresponding change loss_{off,Δ} in detection loss with respect to the off-line samples, the corresponding change loss_{on,Δ} in detection loss with respect to the on-line samples, and the corresponding change loss_{Δ} in the total detection loss may be calculated based on the following formula:

$$∀ change of detection classifier Δ \\ {loss}_{off , Δ} \approx {\prod }_{n}^{ } [ {{p}_{n , 1} ( 1 - {a}_{n} - Δ {a}_{n} )}^{2} + {{p}_{n , 2} ( 1 + {a}_{n} + Δ {a}_{n} )}^{2} + {{p}_{n , 3} ( 1 - {b}_{n} - Δ {b}_{n} )}^{2} + {{p}_{n , 4} ( 1 + {b}_{n} + Δ {b}_{n} )}^{2} ) \\ {loss}_{on , Δ} = {\sum }_{i} {w}_{i} {\prod }_{n} {( {y}_{i} - {h}_{n , Δ} ( {x}_{i} ) )}^{2} \\ {loss}_{Δ} = ( 1 - λ ) \times {loss}_{off , Δ} + λ \times {loss}_{on , Δ} \qquad ( 5 )$$

The detection classifier may be optimized by minimizing the total detection loss.

As an example, the initial detection classifier (e.g. 101 or 301) may be trained in advance by using off-line training. It shall be appreciated that, any appropriate method may be used to off-line train the initial detection classifier, the description of which is omitted here. As another example, the initial detection classifier may be generated on-line or initialized by the object detecting apparatus (the on-line learning device 105 or 305) by using the on-line samples, and then in object detection, the initial detection classifier 101 or 301 may be on-line optimized and updated by using, for example, the method mentioned above, so that the detection performance thereof is improved gradually.

As a particular embodiment, the on-line learning device (e.g. 105 or 305) of the object detecting apparatus may further train and optimize (Step 410 as shown in FIG. 4) the verifying classifier by using the on-line samples according to the verifying result obtained by the verifying classifier and the detection result obtained by the detection classifier. The on-line samples may include the on-line object samples (i.e. image blocks corresponding to the candidate objects that are verified by the verifying classifier as object) and the on-line error samples (i.e. image blocks corresponding to the candidate objects that are verified by the verifying classifier as error detection). In the case shown in FIG. 3 or FIG. 4, the on-line samples may further include the image samples that are marked manually by the user and input via the input device.

As an example, the initial verifying classifier 103 or 303 may be trained in advance by using off-line training. It shall be appreciated that, any appropriate method may be used to off-line train the initial verifying classifier, the description of which is omitted here. As another example, the initial detection classifier 103 or 303 may be generated on-line by the object detecting apparatus (the on-line learning device 105 or 305) by using the on-line samples.

For example, the on-line learning device may generate or optimize the verifying classifier by using the method described below with reference to FIG. 8 or FIG. 9.

FIG. 8 shows an example of on-line optimizing or generating (e.g. step 410) a detection classifier by the on-line learning device (e.g. the on-line learning device 105 or 305).

As shown in FIG. 8, in step 810-1 the on-line learning device updates a statistic distribution model of the object samples and a statistic distribution model of the error samples (each model corresponds to each verifying feature) by using the on-line samples according to the detection result of the detection classifier and the verifying result of the verifying classifier. In other words, for each verifying feature, a statistic distribution model of the object samples and a statistic distribution model of the error samples are established. The statistic distribution model may be any appropriate math statistical distribution model, such as Gaussian model or the like, the description of which is omitted here.

As an example, the on-line learning device may also use both the on-line samples and the off-line samples to update the statistic distribution model of the object samples and the statistic distribution model of the error samples corresponding to each verifying feature). The off-line samples herein are the same as mentioned above, the description of which is not repeated herein.

In step 810-2, the on-line learning device on-line selects the verifying features, i.e. selects one or more verifying features so that the verifying error rate of the verifying classifier is minimized, and generates or updates (optimizes) the verifying classifier by using the verifying features. For a verifying feature, the verifying feature values of the object samples and verifying feature values of the error samples may each correspond to a statistic distribution model (e.g. a Gaussian model). The overlapped area of the two statistic distribution models corresponding to a verifying feature represents the verifying error rate corresponding to this verifying feature. For example, the on-line learning device may use Bayes' Theorem to select the verifying features so that the verifying error rate of the verifying classifier is minimized.

As an example, the verifying classifier may be a strong classifier including a plurality of weak classifiers. Each weak classifier corresponds to a verifying feature and includes one or more statistic distribution models for different object samples or error samples corresponding to this verifying feature (The model may be a Gaussian model or any other appropriate math statistical distribution model). When verifying a candidate object, the verifying classifier may apply each weak classifier to the image block corresponding to the candidate object, to calculate the probabilities that this candidate object belongs to each statistical distribution model of the weak classifier, multiplies the calculated maximum probability value by the weight value of this weak classifier (the weight value of a weak classifier may be determined according to practical application scenario and is not limited to any particular value), and the result is the output of this weak classifier. Then, the verifying classifier calculates the sum of the outputs of the weak classifiers, and if the sum exceeds a predetermined threshold (which may be determined according to practical application scenario, the description of which is omitted here), the verifying classifier determines that the candidate object is an object; otherwise, the verifying classifier determines that the candidate object is an error detection.

FIG. 9 shows an example of on-line selecting verifying features for a verifying classifier including a plurality of weak classifiers.

As shown in FIG. 9, the verifying classifier 903 may include n (n>1) weak classifiers 903-1, . . . 903-i, . . . , 903-n (1≦i≦n). The numeral 908 represents an on-line selection device for selecting the verifying features (step 810-2) in on-line optimizing or generating of a verifying classifier. The on-line selection device 908 may be a component of the on-line learning device 105 or 305.

In the example, each weak classifier uses Gaussian model as the statistical distribution model of the samples. Each weak classifier corresponds to a verifying feature, and includes a plurality of Gaussian models corresponding to the verifying feature. These Gaussian models represent different object samples and error samples. In the on-line selection process, for each training sample (an on-line sample or an off-line sample), the on-line learning device utilizes the verifying classifier to calculate corresponding verifying feature values, and based on the verifying feature values, calculates the probability that the training sample is on each Gaussian model. It is supposed that a weak classifier has C·Gaussian models ω₁, ω₂, . . . , ω_{C}; the central points (mean values) of the Gaussian models are μ₁, μ₂, . . . , μ_{C}, and the variances thereof are Σ₁, Σ₂, . . . Σ_{C}. It is further supposed that the proportion of each class (corresponding to a Gaussian model) in all the classes are P(ω₁), P(ω₂), . . . , P(ω_{C}), wherein

$${\sum }_{i = 1}^{c} P ( {ω}_{i} ) = 1.$$

The probability that a sample which has a feature value x belongs to the ith Gaussian model is as follows:

$${p}_{i} ( x ) = \frac{P ( {ω}_{i} )}{\sqrt{2 π {\sum }_{i}}} exp ( - \frac{1}{2} {( x - {μ}_{i} )}^{2} ) \qquad ( 6 )$$

Supposing the probability pᵢ(x) that the sample belongs to the ith Gaussian model is the maximum, i.e. the sample corresponds to the ith Gaussian model, and then the output of the weak classifier with respect to this sample is the result of multiplying pᵢ(x) by the weight of the weak classifier.

After obtaining the verifying results of the verifying classifier with respect to the samples, the on-line learning device may utilize Bayes' Theorem to select the verifying features that make the error rate of the verifying classifier to be minimum. Then for each selected verifying feature, the on-line learning device may utilize Kalman filtering (or any other appropriate method, such as calculating the mean value of the values of the same feature corresponding to the first several samples, or the like) to generate or update the mean value and variance of the corresponding Gaussian models, so as to generate or optimize the verifying classifier. The on-line learning device (the on-line selection device 908) may select from a feature library 909 the verifying feature corresponding to each weak classifier. The feature library 909 may include a set of predetermined features, and may be saved in a storage device (not shown). The storage device may be a memory built in the object detecting apparatus, or may be a storage unit that is configured outside the object detecting apparatus and may be accessed by the components of the object detecting apparatus.

In practical implementation, the object detecting apparatus may on-line optimize the detection classifier and/or the verifying classifier many times, in order that the detection classifier and/or the verifying classifier can be optimized and updated continuously during object detection. As an example, the object detecting apparatus can, after being started, continuously perform on-line optimization and updating of the detection classifier and/or the verifying classifier (that is, the on-line learning device may be kept in a working state). As another example, the object detecting apparatus may perform on-line optimization and updating of the detection classifier and/or the verifying classifier in a certain period after startup, until the performance of the detection classifier and/or the verifying classifier can meet the practical demand (that is, the on-line learning device may be in a working state within a certain period after startup). As another example, the object detecting apparatus may perform on-line optimization and updating of the detection classifier and/or the verifying classifier periodically at a predetermined interval (that is, the on-line learning device goes into working states periodically).

As an example, the on-line learning device may perform, after the verifying classifier obtains the verifying result of each image frame, on-line optimization of the detection classifier by utilizing the verifying result of the image frame. As another example, the on-line learning device may perform, after the verifying classifier obtains the verifying results of multiple image frames, on-line optimization of the detection classifier by using the on-line samples obtained from the multiple image frames.

The embodiments/examples of the present disclosure may be applicable to object detection of various types of images. For example, the image may be a visible light image, or may be an invisible light image (e.g. a radar image), or may be a combination of multiple spectrum images. In addition, the image may include a single image frame, or may include an image sequence such as video image. The image may be of any size or format as needed, and the present disclosure is not limited to any particular examples.

In the embodiments of the present disclosure, the term “object” may be an object of any type. The embodiments of the present disclosure may be applicable to detect a single class of object, or can be applied to detect multiple classes of objects.

In addition, in the embodiments of the present disclosure, an object or candidate object may be represented by a rectangular region and in such a case, the size of the object may be represented by the area of the region, or may be represented by one or more the width, height, and aspect ratio of the region. In the case that the aspect ratio of the same class of object is constant, the size of the object may be represented by one of the width and height of the rectangular region. Alternatively, an object or candidate object may be represented by a circular region and in such as case, the size of the object may be represented by the area, or the radius or the diameter of the circular region. Of course, an object or candidate object may be represented by any other appropriate shape, which is not numerated herein.

The object detecting method and apparatus according to the embodiments of the present disclosure may be applied to various application scenarios, such as video monitoring, artificial intelligence, or computer vision, or the like. The object detecting method or apparatus according to the embodiments of the present disclosure may be configured to be used in various electronic devices in which object detection is used (in real time or not in real time). Of course, the object detecting method or apparatus according to the embodiments of the present disclosure may also be applicable to other electronic devices having image processing function, such as computer, camera, video recorder, or the like.

It should be understood that the above embodiments and examples are illustrative, rather than exhaustive. The present disclosure should not be regarded as being limited to any particular embodiments or examples stated above.

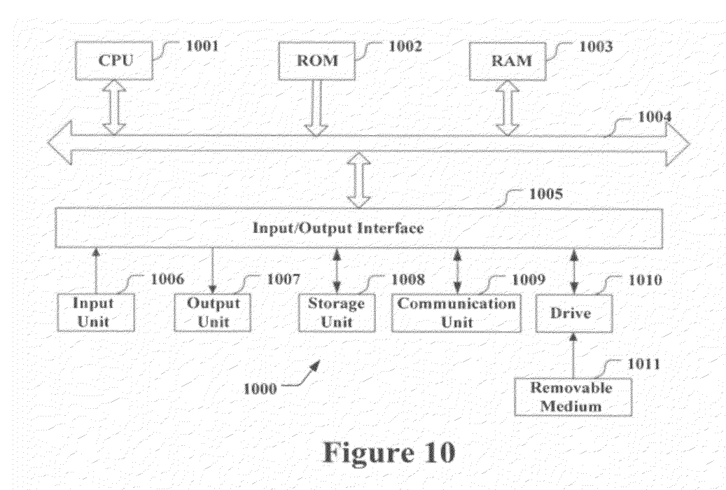

As an example, the components, units or steps in the above apparatuses and methods can be configured with software, hardware, firmware or any combination thereof. As an example, in the case of using software or firmware, programs constituting the software for realizing the above method or apparatus can be installed to a computer with a specialized hardware structure (e.g. the general purposed computer 1000 as shown in FIG. 10) from a storage medium or a network. The computer, when installed with various programs, is capable of carrying out various functions.

In FIG. 10, a central processing unit (CPU) 1001 executes various types of processing in accordance with programs stored in a read-only memory (ROM) 1002, or programs loaded from a storage unit 1008 into a random access memory (RAM) 1003. The RAM 1003 also stores the data required for the CPU 1001 to execute various types of processing, as required. The CPU 1001, the ROM 1002, and the RAM 1003 are connected to one another through a bus 1004. The bus 1004 is also connected to an input/output interface 1005.

The input/output interface 1005 is connected to an input unit 1006 composed of a keyboard, a mouse, etc., an output unit 1007 composed of a cathode ray tube or a liquid crystal display, a speaker, etc., the storage unit 1008, which includes a hard disk, and a communication unit 1009 composed of a modem, a terminal adapter, etc. The communication unit 1009 performs communicating processing. A drive 1010 is connected to the input/output interface 1005, if needed. In the drive 1010, for example, removable media 1011 is loaded as a recording medium containing a program of the present invention. The program is read from the removable media 1011 and is installed into the storage unit 1008, as required.

In the case of using software to realize the above consecutive processing, the programs constituting the software may be installed from a network such as Internet or a storage medium such as the removable media 1011.

Those skilled in the art should understand the storage medium is not limited to the removable media 1011, such as, a magnetic disk (including flexible disc), an optical disc (including compact-disc ROM (CD-ROM) and digital versatile disk (DVD)), an magneto-optical disc (including an MD (Mini-Disc) (registered trademark)), or a semiconductor memory, in which the program is recorded and which are distributed to deliver the program to the user aside from a main body of a device, or the ROM 1002 or the hard disc involved in the storage unit 1008, where the program is recorded and which are previously mounted on the main body of the device and delivered to the user.

The present disclosure further provides a program product having machine-readable instruction codes which, when being executed, may carry out the methods according to the embodiments.

Accordingly, the storage medium for bearing the program product having the machine-readable instruction codes is also included in the disclosure. The storage medium includes but not limited to a flexible disk, an optical disc, a magneto-optical disc, a storage card, or a memory stick, or the like.

In the above description of the embodiments, features described or shown with respect to one embodiment may be used in one or more other embodiments in a similar or same manner, or may be combined with the features of the other embodiments, or may be used to replace the features of the other embodiments.

As used herein, the terms the terms “comprise,” “include,” “have” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

Further, in the disclosure the methods are not limited to a process performed in temporal sequence according to the order described therein, instead, they can be executed in other temporal sequence, or be executed in parallel or separatively. That is, the executing orders described above should not be regarded as limiting the method thereto.

While some embodiments and examples have been disclosed above, it should be noted that these embodiments and examples are only used to illustrate the present disclosure but not to limit the present disclosure. Various modifications, improvements and equivalents can be made by those skilled in the art without departing from the scope of the present disclosure. Such modifications, improvements and equivalents should also be regarded as being covered by the protection scope of the present disclosure.

What is claimed is:

1. An object detecting apparatus, comprising:
a detection classifier, configured to detect an input image to obtain one or more candidate objects in the input image;
a verifying classifier, configured to verify each candidate object by using verifying features from an image block corresponding to the each candidate object; and
an on-line learning device, configured to train and optimize the detection classifier by using image blocks corresponding to the candidate objects as on-line samples, based on verifying results of the candidate objects obtained by the verifying classifier.

2. The object detecting apparatus of claim 1, further comprising:
an input device, configured to receive one or more marked image samples, and
wherein the on-line learning device is configured to train and optimize the detection classifier by using both of image blocks corresponding to the candidate objects and the marked image samples as on-line samples, based on the verifying results obtained by the verifying classifier.

3. The object detecting apparatus of claim 1, wherein the on-line learning device is further configured to train and optimize the verifying classifier by using the on-line samples, based on verifying results obtained by the verifying classifier and detection results obtained by the detection classifier.

4. The object detecting apparatus of claim 3, wherein the on-line learning device is configured to train and optimize the verifying classifier by:
with respect to each verifying feature, updating a statistic distribution model of corresponding object samples and updating a statistic distribution model of corresponding error samples by using the on-line samples, based on the verifying results obtained by the verifying classifier and the detection results obtained by the detection classifier; and
selecting one or more verifying features which makes a verifying error rate of the verifying classifier minimum, to update the verifying classifier.

5. The object detecting apparatus of claim 4, wherein the on-line learning device is further configured to update the statistic distribution model of object samples and the statistic distribution model of error samples corresponding to each verifying feature by using both of the on-line samples and a plurality of off-line samples.

6. The object detecting apparatus of claim 1, wherein the on-line learning device is configured to train and optimize the detection classifier by:
evaluating a first detection loss of the detection classifier with respect to the on-line samples based on detection results of the detection classifier and the verifying results of the verifying classifier; and
optimizing the detection classifier by minimizing the first detection loss.

7. The object detecting apparatus of claim 6, wherein the on-line learning device is further configured to:
calculate a sum or a weighted sum of the first detection loss with respect to the on-line samples and a second detection loss with respect to the off-line samples, as a total detection loss of the detection classifier,
wherein the on-line learning device optimizes the detection classifier by minimizing the total detection loss.

8. The object detecting apparatus of claim 1, wherein the on-line learning device is further configured to train and generate the detection classifier by using the on-line samples.

9. The object detecting apparatus of claim 1, wherein the on-line learning device is further configured to train and generate the verifying classifier by using the on-line samples.

10. The object detecting apparatus of claim 1, wherein the verifying classifier comprises a plurality of weak classifiers each corresponding to a verifying feature, wherein each weak classifier comprises one or more statistical distribution models respectively representing different object samples or error samples.

11. An object detecting method, comprising:
detecting, by a detection classifier, an input image to obtain one or more candidate objects in the input image;
verifying, by a verifying classifier, each candidate object by using verifying features from an image block corresponding to the each candidate object; and
training and optimizing the detection classifier by using image blocks corresponding to the candidate objects as on-line samples, based on verifying results of the candidate objects.

12. The object detecting method of claim 11, further comprising:
receiving one or more marked image samples, and
wherein training and optimizing the detection classifier comprises: training and optimizing the detection classifier by using both of image blocks corresponding to the candidate objects and the marked image samples as on-line samples, based on the verifying results of the candidate objects.

13. The object detecting method of claim 11, further comprising:
training and optimizing the verifying classifier by using the on-line samples, based on verifying result obtained by the verifying classifier and detection results obtained by the detection classifier.

14. The object detecting method of claim 13, wherein training and optimizing the verifying classifier comprises:
with respect to each verifying feature, updating a statistic distribution model of corresponding object samples and updating a statistic distribution model of corresponding error samples by using the on-line samples, based on the verifying results obtained by the verifying classifier and the detection results obtained by the detection classifier; and
selecting one or more verifying features which makes a verifying error rate of the verifying classifier minimum, to update the verifying classifier.

15. The object detecting method of claim 14, wherein updating the statistic distribution model of object samples and the statistic distribution model of error samples corresponding to each verifying feature comprises:
updating the statistic distribution model of object samples and the statistic distribution model of error samples corresponding to each verifying feature by using both of the on-line samples and a plurality of off-line samples.

16. The object detecting method of claim 11, wherein training and optimizing the detection classifier comprises:
evaluating a first detection loss of the detection classifier with respect to the on-line samples based on detection results of the detection classifier and the verifying results of the verifying classifier; and
optimizing the detection classifier by minimizing the first detection loss.

17. The object detecting method of claim 16, wherein training and optimizing the detection classifier further comprises:
calculating a sum or a weighted sum of the first detection loss with respect to the on-line samples a second detection loss with respect to the off-line samples and, as a total detection loss of the detection classifier,
wherein optimizing the detection classifier comprises minimizing the total detection loss.

18. The object detecting method of claim 11, further comprising:
training and generating the detection classifier by using the on-line samples.

19. A computer program product, comprising program codes which, when loaded into a memory of a computer and executed by a processor of the computer, cause the processor to perform the following steps of:
detecting an input image to obtain one or more candidate objects in the input image;
verifying each candidate object by using verifying features from an image block corresponding to the each candidate object; and
training and optimizing the detection classifier by using image blocks corresponding to the candidate objects as on-line samples, based on verifying results of the candidate objects.

20. A computer readable storage medium, having computer program thereon, the computer program comprising program codes which, when loaded into a memory of a computer and executed by a processor of the computer, cause the processor to perform the following steps of:
detecting an input image to obtain one or more candidate objects in the input image;
verifying each candidate object by using verifying features from an image block corresponding to the each candidate object; and
training and optimizing the detection classifier by using image blocks corresponding to the candidate objects as on-line samples, based on verifying results of the candidate objects.
